(19) United States
(12) Patent Application Publication
(10) Pub. No.: US 2006/0281059 A1
(43) Pub. Date: Dec. 14, 2006

(54) Method and Setting for Social Conflict Resolution

(76) Inventor: Carol Ann Trufant, Oakland, CA (US)

Correspondence Address: Oleh Weres;Sonoma Research Company, 101 S. Coombs St., Suite L, Napa, CA, 94559, US

(21) Appl. No.: 11/462,913

(22) Filed: Aug. 7, 2006

Related U.S. Application Data
(63) Continuation-in-part of application No. 09/591,147, filed on Jun. 9, 2000, now abandoned.

(51) Int. Cl. G09B 19/00

(52) U.S. Cl. 434/236

(57) ABSTRACT

A physical setting to conduct group counseling and mediation is provided; this setting consists of a series of rooms or room partitions divided and organized to facilitate communication and conflict resolution among participants representing the parties to a conflict. A method for producing a consultant's report containing recommendations for resolving a specific conflict is also provided. This method is used by a consultant, counselor or mediator working with three or more parties in conflict; for example, at a workplace, within a local community, in a school, or within a family. The method involves defining the conflict, and dividing the participants into three groups which discuss the conflict among and within the groups under the guidance of the consultant, in a sequence of steps which encourage exchange and mutual understanding. Finally, the consultant delivers a written or oral report with recommendations for resolving the conflict.

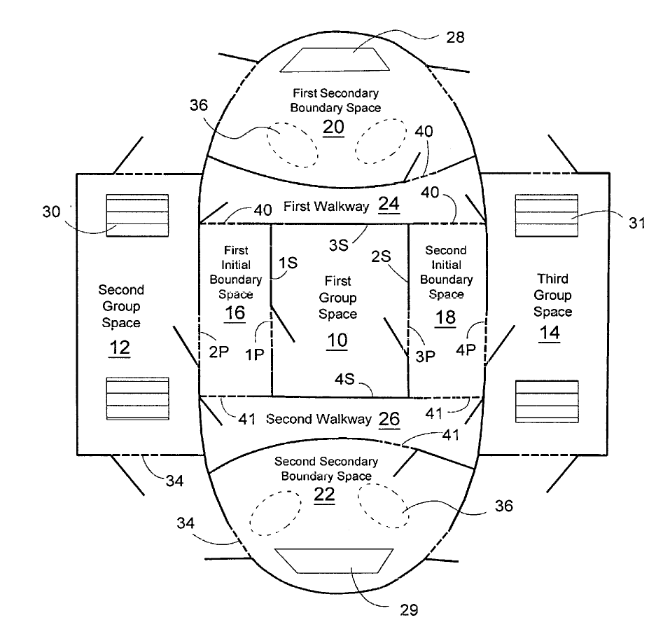

### CROSS-REFERENCE TO RELATED APPLICATIONS

This application is a continuation-in-part of U.S. patent application Ser. No. 09/591,147.

### STATEMENT REGARDING FEDERALLY SPONSORED RESEARCH OR DEVELEOPMENT

Not Applicable

### Reference to Microfiche Appendix

Not Applicable

### Copyright Notice

A portion of the disclosure of this patent document contains material which is subject to copyright protection. The copyright owner has no objection to facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention

The present invention relates to a method and physical setting for conflict resolution. A physical setting to conduct a conflict resolution exercise is provided; this setting consists of a series of rooms or room partitions divided and organized to facilitate communication and conflict resolution among representatives of the groups in conflict.

A method for producing a consultant's report containing recommendations for resolving a specific conflict is also provided. This method is to be used by a consultant, counselor or mediator working with parties in conflict; for example, at a workplace, within a local community, in a school, or within a family. The method involves defining the conflict, and dividing the participants into three groups which discuss the conflict among and within the groups under the guidance of the consultant, in a sequence of steps which encourage exchange and mutual understanding. Finally, the consultant delivers a written or oral report with recommendations for resolving the conflict.

2. Prior Art

Clinical psychology as practiced by conflict resolution consultants is the field of endeavor pertaining to my invention. More than 13 years ago, I became interested in Tavistock group relations while co-leading a psychoanalytic object relations (Kleinian) group for 1 year during my general internship at Neuropsychiatric Institute at UCLA, July 1974 through June 1975.

Generally, group relations work is concerned with studying how group and individual dynamics in organizations affect each other in relationship to task completion. Participation and staff consultation in said conferences afforded me more experience and appreciation of the plausibility of using different ways of relating to others and resolving conflict. This interest coupled with my prior and continuing one in various systems such as family, community, ecological, structural, paradoxical, and ‘living’, the latter most closely related to Tavistock group relations, all contributed to my current view of possibilities for inter- (intra-) group workable collaborations.

Approaches to resolving conflicts by negotiation encompass three concepts: 1) Controlling projections and splitting (discounting); 2) Recognition; and 3) Reframing. Basically, bridging a gap resolves splitting; one then can see (recognize) the persons across that “divide”; thereafter, different perspectives and collaborations have opportunities to be formed.

The following hypothesis underlie the formulation of my invention:

1) An open theater method will provide optimum opportunities for face-to-face negotiating, understanding others' points of view by experiencing their tasks in role, and reducing stereotypic inferences. Time will be a significant factor for the success of conflict resolution (Mangham & Overington, 1987; Miller, 1985; Wall & Blum, 1991; Lewin, 1997; Cordes, 1986; Rubin & Friedland, 1986; Coombs, 1987; Churchill, 1989; Stuart, 1988; Miller & Rice, 1967; Schein, 1996; Friedman, 1994).

2) Successful conflict resolution is more likely when the presence of psychological “splitting” both within and between conflict groups is recognized. “Splitting” describes a process whereby groups, subgroups and individual project onto others their own dilemmas and anxieties about exercising authority or wielding power (Klein, 1971; DeBoard, 1978; Horowitz, 1985; Klein et al., M, 1985; Lewin, 1997; White, 1966; Katz, 1988; Klein, 1985; Keen, 1982; Trufant, 1983; Rather, 1987; Fiske, 1993; Khaleelee & Miller, 1985; Hogget & Lousada, 1985).

3) Conflict between groups lessens in direct proportion to the degree that these groups address conflict within themselves. (Hassner, 1975; Chattopadhyay, 1989; Kipnis, 1984; Miller, 1985A; Kets de Vries, 1991; Alderfer & Klein, 1985; Kets de Vries & Miller, 1984; Kemberg, 1985; Sievers, 1995; Hom, 1988; Hirshhorn, 1997; Lewin, 1997; Conflict and Cooperation Among Groups: An Experimental Workshop in the Tavistock Tradition, 1987; Van Dijk, 1987; Wilson, 1996).

4) To recognize “splitting” in the groups with which they are involved, people need an opportunity to move outside of them in order to reframe their picture of what is happening (Lawrence, 1985; Watzlawick, 1974; Boszormenji-Nagy, 1973; Minuchin, 1974; Baldwin et al., 1982; Dooley, 1997; Eisold, 1985; Bion, 1985; Miller & Rice, 1967; Argyris, 1967; Lewin, 1997; Klein et al., 1998; Verhofstadt-Deneve, 1995; Noe & Wilk, 1993).

5) A useful starting point for conflict resolution is to classify and reframe the conflict following the outline proposed by Coombs, 1987: Type I Conflict—Persons must choose between two opposites: Type II Conflict—Persons who desire two different things must choose only one; Type III Conflict—Persons who want the same thing, must settle for different things (Also see Deutsch, 1977; Lewin, 1997; Strodtbeck, 1951).

### REFERENCE

Alderfer, C., & Klein, E., 1985. Affect, leadership and organizational boundaries. In A. Colman and M. Geller's (Eds) Group Relations Reader 2, 197-211.
Argyris, C., 1967. Some Causes of Organizational Ineffectiveness. Washington, DC: (Center for International Systems Research, Occasional Papers, No.2), Department of State.
Baldwin, A., Cole, R., & Baldwin, C. (eds). 1982. Parental pathology, family interaction, and the competence of the child in school. Monographs of the Society for Research in Child Development, 47(5, Serial No. 197), 3.
Bion, W., 1985. Container and contained. In A. Colman and M. Geller's (Eds) Group Relations Reader 2, 127-133. Washington, DC: A.K. Rice Institute.
Boszormenji-Nagy, I., & Spark, G., 1973. Invisible Loyalities. New York: Harper and Row.
Brown, R. (1965). Social Psychology. New York: The Free Press, 420-422; 549-550; 558; 576-580.
Chattopadhyay, G., 1989 (June). The Illusion That Was India. (Available from Indian Institute of Management, P.O. Box 16757, Alipore P.O., Calcutta-700 027, India). Working Paper Series-117(89), 1-30.
Churchill, C., 1989. Serious Money (a play—West Coast Preview). Berkeley, Calif.: Berkeley Repertory Theatre, June 4.
Conflict and Cooperation Among Groups: An Experiential Workshop in the Tavistock Tradition. 1987 (July 4). International Society of Political Psychologists, San Francisco.
Coombs, C., 1987. The structure of conflict. American Psychologist, 42(4), 355-363.
Cordes, C., 1986. Responding to terrorism: conflict theory offers insight. APA Monitor (May), 36-37.
De Board, R., 1978. The Psychoanalysis of Organizations: A Psychoanalytic Approach to Behavior in Groups and Organizations. London: Tavistock publications Limited.
Deutsch, M., 1977. The Resolution of Conflict: Constructive and destructive processes (2nd ed.). New Haven and London: Yale University Press.
Dooley, K. J., 1997. A complex adaptive systems model of organization change. Nonlinear Dynamics, Psychology, and Life Sciences, 1(1), 69-97.
Eisold, K., 1985. Recovering Bion's contributions to group analysis. In A. Colman, and M. Geller's (Eds) Group Relations Reader 2, 37-48.
Fiske, S. T., 1993. Controlling other people: The impact of power on stereotyping. American Psychologist, 48(6), 621-628.
Friedman, R. A., 1994. Front Stage, Backstage: The dramatic structure of labor negotiations. Cambridge, Mass.: The MIT Press.
Hassner, P., 1975. Integration and cooperation or inequality and dependence? International Journal of Politics, 5(1), 59-84.
Hirschhorn, L., 1997. Reworking Authority: Leading and following in the post-modern organization. Cambridge, Mass., The MIT Press.
Hogget, P., & Lousada, J., 1985. Therapeutic intervention in working class communities. Free Associations: Psychoanalysis, groups, politics, culture, 1, 125-152.
Horn, A., 1988. The Crisis Clinic in Crisis. Paper presented at the First International Symposium on Group Relations: Contributions to Social and Political Issues, Oxford Univ., England, July 15-18.
Horowitz, L., 1985. Projective identification in dyads and groups. In A. Colman and M. Geller's (Eds) Group Relations Reader 2, 21-35.
Katz, E., 1988. Conflict and Coexistence as Manifested in a Consultation of a Jewish-Palestinian Community. Paper presented at the First International Symposium on Group Relations: Contributions to Social and Political Issues. Oxford University, England, July 15-18.
Keen, S., 1982. War as the ultimate therapy. Psychology Today, June, 56-66.
Kernberg, O., 1985. Regression in organizational leadership. In A. Colman and M. Geller's (Eds) Group Relations Reader 2, 89-107.
Kets de Vries, M. F. R., 1991. Organizations on the Couch: Clinical perspectives on organizational behavior and change. San Francisco: Jossy-Bass Publishers, 1-21.
Kets de Vries, M. & Miller, D. (1984, October). Unstable at the top. Psychology Today, 26-34.
Khaleelee, O. and Miller, E., 1985. Beyond the small group. In M. Pines' (Ed) Bion and Group Psychotherapy, 353-383.
Kipnis, D., 1984. The view from the top. Psychology Today, December, 30-36.
Klein, E. B., 1985. Belfast communities intervention. In A. Colman & M. Geller's (Eds) Group Relations Reader 2, 301-306.
Klein, E. B., Gabelnick, F., & Herr, P, (Eds), 1998. The Psychodynamics of Leadership. Madison, Conn.: Psychosocial Press, An Imprint of IUP, 3-75; 109-125.
Klein, E. B., Thomas, C. S., & Bellis, E. C., 1971. When warring groups meet: The uses of a group approach in police-Black community relations. Social Psychiatry, 6(2), 93-99.
Klein, M., 1985. Our adult world and it's roots in infancy. In A. Colman and M. Geller's (Eds) Group Relations Reader 2, 5-19.
Lawrence, W. G., 1985. Beyond the frames. In M. Pines' (Ed) Bion and Group Psychotherapy, 306-329.
Lewin, K., 1997. Resolving Social Conflicts/Field Theory in Social Science. Washington, DC: American Psychological Assn, 200-211; 231-261; 107-115; 143-154.
Mangham, I. L., & Overington, M. A., 1987. Organizations As Theatre: A social psychology of dramatic appearances. New York: John Wiley & Sons
Miller, E., 1985a. Organizational development and industrial democracy: a current case-study. In A. Colman and M. Geller's (Eds) Group Relations Reader 2, 243-271.
Miller, E., 1985b. The politics of involvement. Ibid, 383-397.
Miller, E. J., & Rice, A. K., 1967. Systems of Organization: The control of task and sentient boundaries. London: Tavistock Publications.
Minuchin, S., 1974. Families and Family Therapy. Cambridge: Harvard University Press.
Noe, R. A., & Wilk, S. L., 1993. Investigation of the factors that influence employees' participation in development activities. Journal of Applied Psychology, 78(2), 291-302.
Rather, D., 1987 (December 27). CBS TV News Special, San Francisco, Calif. [Subject: The Gorbachev/Reagan signing of the Disarmament Pact].
Rubin, J., and Friedland, N., 1986. Theater of terror. Psychology Today, March, 18-28.
Schein, E. (1996). Strategic Pragmatism: The Culture of Singapore's Economic Development Board. Cambridge, Mass.: The MIT Press.
Sievers, B. (1995). Characters in search of a theatre: Organization as theatre for the drama of childhood and the drama at work. Free Associations: Psychoanalysis, Groups, Politics, Culture, 5. (PT 2) (34), 196-220.
Strodtbeck, F., 1951. Husband-wife interaction over revealed differences. American Sociological Review, 16, 468-473.
Stuart, 0., 1988. ISO on it's own: the power of optimism. Dance Magazine, 62(8), 44-45.
Trufant, C., 1983. Displacement and Other War-Related Phenomena (Revised). Unpublished letter-to-the-editor.
Trufant, C. A., 1989. A Proposal for Social Conflict Resolution on an International, National or Local Level. Unpublished Manuscript.
Trufant, C. (1999). Social conflict resolution: An intergroup working model. Poster session presented at the 7th biennial meeting of the Society for Community Research and Action; Div 27, Community Psychology; American Psychological Association; New Haven, Conn..
Trufant, C. A. (2002). U.S. Pat. No. D467,615.
U.S. Office of Strategic Services (1948). Assessment of Men: Selection of Men for the Office of Strategic Services. Johnson Reprint Corp.
Van Dijk, T. (1987). Communicating Racism: Ethnic Prejudice in Thought and Talk. Beverly, Calif.: Sage Publications.
Verhofstadt-Deneve, L. M.(1995). How to work with dreams in Psychodrama: developmental therapy from an existential-dialectical viewpoint. International Journal of Group Psychotherapy, 45(3), 405-435.
Wall, J. A., & Blum, M., 1991. Community mediation in the People's Republic of China. Journal of Conflict Resolution, 12(1), 3-20.
Watzlawick, P., Weakland, J., & Fisch, R. (1974). Change: Principles of Problem Formation and Problem Resolution. New York: W. W. Norton & Company.
Weakland, J. (1960). The “double bind” hypothesis of schizophrenia and three-party interaction. In D. Jackson (ed), The Etiology of Schizophrenia. New York: Basis Books, 373-388.
White, R. K., 1966. Misperception and the vietnam war. The Journal of Social Issues, 22(3), 1-19.
Wilson, J. (1996, July 25). Corporate ethics and gang culture. San Francisco Chronicle, p. A25.

### BRIEF DESCRIPTION OF THE INVENTION

The purpose of the present invention is to have participants practice taking personal responsibility for behavior and resolution of differences (which constitute the conflict) and problem solving through interactive learning. Adults have difficulty authorizing themselves and others to take on leadership roles, often resulting in a lack of resolution of group issues; i.e., rudeness, low work productivity, workplace violence, community conflicts and world tension. Time, role, and formality affect our propensity to hoard power, project anxieties and dilemmas about exercising power, and taking responsibility for change, across and within groups. Movement outside of one's framework, either individual, intra-, or intergroup enhances recognition of others' views, beliefs, and provides an environment more accessible to dialogues toward collaborative problem solving.

The present invention combines concepts and ideas found in the literature to produce a novel and useful method for conflict resolution which culminates in the production of a consultant's report containing recommendations aimed at resolving the conflict. This collective conflict resolution exercise preferably is conducted in a novel physical setting of rooms and/or partitions designed to maximize useful interaction among the participants.

Use of open process vs. hidden (backstage) agreement/deal making to resolve conflicts, disagreements, stalemates, etc., is key. Everyone in attendance has the potential of contributing, being recognized as such, and participating (or not) in reframing questions issues, etc., toward resolution—all of this is hard work. This open approach lessens the possibility of betrayals and covert actions, because the whole process has to be observed by all of the participants to be valid as a basis for agreement. There is potential for development of trust over time.

Ordinarily, a large room will be used, subdivided with partitions as illustrated in the drawing. Ideally, a concentric arrangement of tiered seating should be provided, resembling bleachers or a theater in the round. Each of the three groups in the exercise will have its own group space, and there will be vestibular boundary spaces connected with the group spaces through swinging gates or doors, allowing negotiations to take place among the groups “on neutral ground.” Swinging doors or gates will also be present at either end of each initial boundary area, allowing access to the secondary boundary areas. The purpose of these secondary boundary areas is to provide space for participants to move into them and reframe the issues. The participants can then trace the difference in climate as they move from the initial to the secondary boundary areas, and from the old into the new frames of reference. The secondary boundary spaces will each be furnished with 2 or 3 comfortable chairs, a big, round rug in the middle (conducive to sitting on, if desired), and perhaps 1 or 2 throw rugs. The very best setting for this exercise might be a country-type house or barn as described in the classic book Assessment of Men: Selection of Men for the Office of Strategic Services. A gym, any large room, or even a town square will do; a theater-in-the-round would be ideal. What is needed is a holding environment wherein negative energy can be contained by the consultant and staff and reworked or reframed into positive energy.

The conflict resolution exercise will take place under the direction and supervision of a consultant, counselor or mediator. In the interest of brevity this person will be referred to as the “consultant” hereinafter; the use of this term is intentionally broad, and is not meant to restrict the operation of the invention to a consultant of a specific educational background or occupational designation.

In the specification and in the claims, the phrase “under the consultant's direction” means just that: the consultant tells the participants to execute a specific series of concrete steps, and the product of the method is also concrete: the consultant's report contained recommendations on how to resolve the conflict.

A wide variety of conflict situations can be addressed and resolved using my invention; for example, a conflict within an urban community where the identifiable interest groups or parties to a conflict typically are: (a) The People in the Community; (b) City/County Politicians and Officials; and (c) Community Activists. The same approach can be applied in other contexts; for example, a work-place conflict situation, where the parties might be (a) The Workers; (b) Top Management; and (c) Middle Management. Typical conflicts or issues arising in a workplace and amenable to the method of this invention would be work productivity, workplace environment, and workplace violence. In case of a conflict within a school, the identifiable interest groups would be: (a) Students; (b) Teachers; and (c) Parents. The same approach could even be applied in the international context; for example, to mediate the terrible conflict among (a) The State of Israel; (b) The Government of Lebanon; and (c) the non-state entity known as Hezbollah.

### BRIEF DESCRIPTION OF THE DRAWING

The drawing depicts my novel setting for conflict resolution.

### DETAILED DESCRIPTION OF THE INVENTION

Method

I will describe my invention in reference to a community conflict involving Community, Politicians, and Activists; the same description can be applied to other sorts of conflicts (not limited to those identified above) by substituting the names of the corresponding parties or groups.

At the start of the counseling process, participants of the conflict resolution exercise representing parties to the conflict will be assembled, and a group discussion conducted precisely to define the conflict and specific issues to be addressed and set goals for the conflict resolution exercise. Then the participants will be randomly divided into three groups assigned to play the roles and argue the positions of The Community, The Politicians, and The Activists. Three or more volunteers will be assigned to function as a “Chorus.”

The physical setting for the exercise—illustrated in the drawing—is an arrangement of rooms or room partitions which provides three group spaces for the three groups to use separately, plus four “boundary spaces” connected to the three group spaces, wherein the group participants can meet on neutral ground to discuss their differences. Preferably, these various physical spaces should be connected by swinging doors which provide privacy while allowing easy entry to the boundary spaces. The setting is described in detail below.

The groups will be directed to go to their respective group spaces, and after discussing the issues within each group in its respective group space, the groups will meet and discuss in the two “initial boundary spaces”. If issues cannot be resolved in the initial boundary spaces, then interaction of the participants and discussion of the issues will be moved to the “secondary boundary spaces” for further work. Couches, rugs and a more comfortable space are provided in the secondary boundary spaces, allowing the participants to relax and be more open to reframing and change in their positions.

While the groups are discussing the issues, the chorus members will openly discuss the progress of the exercise among themselves, provide a running commentary upon unfolding events for all to hear, and communicate suggestions to the consultant. The chorus will help the consultant reframe disagreements that cannot be resolved “in place.” Throughout these discussions, the consultant will move freely from area to area. In case the consultant decides his/her input is not needed, he/she will stand back and observe. The consultant and chorus may or may not be in agreement at any given time.

Then the identities of the three groups will be rotated; for example, the group representing The Activists will assume the role of The Community, the group representing The Community will assume the role of The Politicians, and the group representing the Politicians will assume the role of the Activists. The original members of the chorus will be distributed among the groups, and new chorus members will be selected.

An additional round of discussion/interaction will be conducted as above. Then, the entire cycle of rotation and discussion will be repeated at least once. Additional repetitions of the cycle may be added if time permits and the consultant so recommends.

The time needed to conduct the exercise will normally be 3½ hours divided as follows:

30 minutes to explain the process and get everyone assigned to a group and seated;

30 minutes for discussions and interaction to occur;

15 minutes to rotate the groups and reassign their roles;

30 minutes for a second round of discussion;

15 minutes to again rotate the groups;

30 minutes for a third round of discussion and interaction.

Finally, 60 minutes will be provided for discussion of the event by the participants about the various roles they assumed during the exercise and how these roles might affect their behavior towards authority and leadership “in the real world” where the conflict actually exists. First, review will take place within each group and with the three groups all together for 20 minutes to ensure comprehension of the process. Then, each group will break-up into small groups of 5-8 persons, and continue the review process for another 20 minutes (Gosling, 1967). The consultant will be available to assist the small groups when requested. Room space will be allocated and used as needed to provide a quiet environment for each of these smaller groups to talk. The final 20 minutes of the hour will be used for the application phase; that is, applying what participants learn and feel comfortable using to help resolve conflict in their “real world” setting.

An extra 20 minutes will be added to the exercise for debriefing participants if necessary. Additional time may be allotted for consideration of follow-up issues that might be identified and defined during the exercise.

A one page Likert-type form questionnaire will be distributed to participants at the end of the day to discover what they have learned about taking individual responsibility around issues of authority, fellowship, and collaboration, i.e., what was discovered in regard to intra- or inter-group relation functioning, views of ‘others’, conflict resolution, and collaboration. Fifteen minutes will be allotted for completing the questionnaire.

Finally, the consultant will review the questionnaires, formulate his/her recommendations, and provide the participants and/or the client who requested the consultant's service with a report with recommendations for resolving the conflict. This report may be delivered orally or in written form.

Optionally and preferably, follow-up group sessions meeting weekly or monthly should follow for a period of three to six months following the main conflict resolution exercise.

Setting

The preferred physical setting for the exercise is shown in the drawing. The exact configuration depicted is representative, and should not be construed as limiting the scope of the invention but merely as providing an example of the presently preferred embodiment.

The different spaces illustrated may be separated by permanent walls or by some kind of movable partitions. The setting may be created as a special purpose building, a permanent part of a building, or as a temporary arrangement of partitions, panels or boundary markers within an existing building, a single large room, or even in an appropriate outdoor space; for example, a school yard, a park, or a town square.

The setting includes the following spaces and features:
a first group space 10 having a first side IS, a second side 2S, a third side 3S and a fourth side 4S,
a first initial boundary space 16 located adjacent to first side IS of first group space 10 and connected to it with a first portal 1P,
a second group space 12 located adjacent to first initial boundary space 16 and opposite from first group space 10 and connected to first initial boundary space 16 with a second portal 2P,
a second initial boundary space 18 located adjacent to second side 2S of first group space 10 and connected to it with a third portal 3P,
a third group space 14 located adjacent to second initial boundary space 18 and opposite from first group space 10 and connected to second initial boundary space 18 with a fourth portal 4P,
a first secondary boundary space 20 located near third side 3S of first group space 10,
a second secondary boundary space 22 located near fourth side 4S of first group space 10,
and a second set of portals 34 allowing persons to pass between: second group space 12 and first secondary boundary space 20; second group space 12 and second secondary boundary space 22; third group space 14 and first secondary boundary space 20; and third group space 14 and second secondary boundary space 22.

As illustrated, first initial boundary space 16 and second initial boundary space 18 are on opposite sides of first group space 10, and first secondary boundary space 20 and second secondary boundary space 22 are also located on opposite sides of first group space 10.

In the preferred embodiment, the following features are also present:
the two secondary boundary spaces 20 and 22 each contain a raised stage area, respectively 28 and 29 in the drawing, which can be observed by persons in the respective secondary boundary space;
at least one set of tiered seating, 30 and 31 in the drawing, in each of the second and third group spaces, respectively 12 and 14 in the drawing;
walkway 24 connecting first initial boundary space 16, second initial boundary space 18, and said first secondary boundary space 20 by means of a third set of portals 40,
a second walkway 26 connecting first initial boundary space 16, second initial boundary space 18 and second secondary boundary space 22 by means of a fourth set of portals 41,
and furnishings in the two secondary boundary spaces 20 and 22 to make them more comfortable and relaxing for the participants; for example, chairs, couches and rugs.

Preferably, at least the four portals 1P, 2P, 3P and 4P should be swinging doors, and ideally, all of the portals in the setting should be swinging doors. However, other types of portals may be used; for example, curtains, gates, ordinary doors, etc..

### Conclusions and Ramifications

Although the description above contains many specificities, these should not be construed as limiting the scope of the invention but merely as providing examples of some of the presently preferred embodiments. Thus the scope of the invention should be determined by the appended claims and their legal equivalents, rather than by the examples given.

This method of conflict resolution addresses our ecological understanding that a relationship between humans and our surroundings exists, and that our relationship to space and distance from one another in groups affects human interaction. Space may seem less ominous if we all are watching, and experiencing subplacements such as movement into boundary spaces and around one's own group.

Violence, lack of conflict resolution in the public schools system, and in the workplace in the US, especially are issues amenable to resolution by application of the present invention, which can be used to urge city planners and others to build with ideas in mind of common areas in ordinary work spaces rather than outside of them like break rooms. Also small group areas and boundary spaces could be devised for negotiating; for example, a classroom.

My method can also be used to resolve conflicts involving more than three parties: participants representing three of the parties assume the role of the three primary groups in the exercises, while representatives of the other parties serve as the chorus. This technique offers an efficient approach to resolving tough conflicts (i.e, Coombs, 1987, stage 3; Weakland, 1960; Brown, 1965, 421, 3rd para; 2nd para; 558).

For example, the present day conflict related to possible acquisition by North Korea of nuclear weapons involves six parties with differing viewpoints and interests: North Korea, the United States, South Korea, China, Russia and Japan. My method could be applied to this conflict by temporarily recasting the conflict as one that involves just three parties; for example, North Korea, the United States, and China. Representatives of these three countries would assume the role of primary participants in the conflict resolution exercise, while representatives of the other three countries (South Korea, Japan and Russia) would serve as the chorus. The chorus would offer commentary and advice from their perspective about unseen factors that could be helpful to the main group and consultant directing the exercise. The latter three groups serving as the Chorus would be more acceptable advisors or commentors since these groups are more familiar with one another than not. It allows the groups less involved at the moment to contribute beneficially to the conflict resolution process. A Chorus comprising more than one group could rotate leadership of the Chorus amongst themselves.

The three primary groups would exchange their roles in the manner specified, and having completed three or more cycles of assignment and discussion, the six groups would be reassigned among the three primary groups and the Chorus, following which the exercise would be repeated as might be necessary.

1. A setting for conflict resolution, comprising:
a first group space having a first side, a second side, a third side and a fourth side,
a first initial boundary space located adjacent to said first side of said first group space and connected thereto with a first portal,
a second group space located adjacent to said first initial boundary space and opposite from said first group space and connected to said first initial boundary space with a second portal,
a second initial boundary space located adjacent to said second side of said first group space and connected thereto with a third portal,
a third group space located adjacent to said second initial boundary space and opposite from said first group space and connected to said second initial boundary space with a fourth portal,
a first secondary boundary space located near said third side of said first group space,
a second secondary boundary space located near said fourth side of said first group space,
and a second set of portals allowing persons to pass between
said second group space and said first secondary boundary space,
said second group space and said second secondary boundary space,
said third group space and said first secondary boundary space,
and said third group space and said second secondary boundary space,
wherein said first initial boundary space and second initial boundary space are on opposite sides of said first group space and
wherein said first secondary boundary space and said second secondary boundary space are located on opposite sides of said first group space.

2. The setting of claim 1, wherein
said first secondary boundary space contains a first stage area which can be observed by persons in said first secondary boundary space, and
said second secondary boundary space contains a second stage area which can be observed by persons in said second secondary boundary space.

3. The setting of claim 1, additionally provided with
at least one set of tiered seating in said second group space,
and at least one set of tiered seating in third group space.

4. The setting of claim 1, additionally provided with
a first walkway connected to said first initial boundary space and said second initial boundary space and said first secondary boundary space by a third set of portals, and
a second walkway connected to said first initial boundary space and said second initial boundary space 18 and said second secondary boundary space by a fourth set of portals,
wherein
said first walkway is located between said first group space and said first secondary boundary space,
and said second walkway is located between said first group space and said second secondary boundary space.

5. The setting of claim 1, wherein said first secondary boundary space and said second secondary boundary space are each provided with at least one item of interior furnishing selected from the class consisting of chairs, couches and rugs.

6. The setting of claim 1, wherein said first portal, said second portal, said third portal and said fourth portal are swinging doors.

7. A method for generating a consultant's report aimed at resolving a conflict within a gathering of participants, the method comprising the steps identified below, which are conducted under said consultant's direction and supervision:
(a) definition of the conflict to be resolved;
(b) random assignment of a plurality of participants into a first group, a second group and a third group, each said group finally comprising a plurality of members;
(c) selection of a plurality of participants to act as a chorus;
(d) direction of said group members into separate group spaces based on the group assignments from step (b);
(e) discussion by at least two of said groups of said conflict in at least one neutral space, wherein said neutral space is connected with at least two of said separate group spaces;
(f) provision by said chorus participants of a commentary as step (e) takes place;
(g) rotation of the group members such that said first group becomes said second group, said second group becomes said third group and said third group becomes said first group;
(h) reassignment of said chorus participants into said first, second and third groups;
(i) selection of new chorus participants;
(j) repetition of steps (e) and (f);
(k) repetition of steps (g), (h) and (i);
(i) repetition of steps (e) and (f);
(m) discussion of said conflict by said gathering of participants together;
(n) and the provision by said consultant of said report aimed at resolving said conflict.

8. The method of claim 7, wherein step (m) includes the additional substeps:
(m)(i) discussion by the members of said first, second and third groups amongst themselves;
(m)(ii) and breaking each of said first, second and third groups into smaller groups followed by further discussion within said smaller groups.

9. The method of claim 7, further comprising the step of:
(n) directing each participant of said gathering to complete an evaluation form recording what each participant has learned during steps (b) through (m).

10. The method of claim 9, wherein said evaluation form is substantially a Likert-type form.

11. The method of claim 7, wherein step (f) includes the additional substep
(f)(i) of communicating said commentary to said consultant.

12. The method of claim 7, further comprising the steps of:
(p) extending the time allowed for operation of said method;
(q) and directing said participants of said gathering to discuss one or more follow-up issues that have been identified during the preceding steps.

13. The method of claim 7, wherein said conflict concerns at least one workplace issue.

14. A method for generating a consultant's report aimed at resolving a conflict related to a workplace and involving a gathering of participants, wherein said method comprises the steps identified below, which are conducted under said consultant's direction and supervision:
randomly assigning a plurality of said participants into a first group, a second group and a third group, each said group finally comprising a plurality of members;
selecting a plurality of said participants to act as a chorus;
directing group members into group spaces based on the group assignments;
directing said groups to discuss said conflict in at least one neutral space, wherein said neutral space is connected with at least two of said separate group spaces;
directing said chorus participants provide a commentary as the preceding step takes place;
rotating said group members such that said first group becomes said second group, said second group becomes said third group and said third group becomes said first group;
reassigning and distributing said plurality of chorus participants among said first, second and third groups;
selecting new chorus participants; and
directing a plurality of said participants of said gathering to discuss said conflict.

15. The method of claim 14, wherein said conflict concerns work productivity.

16. The method of claim 14, wherein said conflict concerns workplace violence.
